(19) United States
(12) Patent Application Publication
(10) Pub. No.: US 2018/0300087 A1
(43) Pub. Date: Oct. 18, 2018

(54) SYSTEM AND METHOD FOR AN IMPROVED REAL-TIME ADAPTIVE DATA COMPRESSION

(71) Applicant: DATERA, INC., Sunnyvale, CA (US)

(72) Inventors: RYAN AUBREY STILES, EAST PALO ALTO, CA (US); GUILLERMO JUAN ROZAS, LOS GATOS, CA (US)

(73) Assignee: DATERA, INC., SUNNYVALE, CA (US)

(21) Appl. No.: 15/488,407

(22) Filed: Apr. 14, 2017

(51) Int. Cl. G06F 3/06

(52) U.S. Cl. CPC G06F 3/0661; G06F 3/0685; G06F 3/0608

(57) ABSTRACT

The present invention is mainly to solve the technical problems of the prior art existed. The present invention relates to compression, in particular to an improved real-time adaptive data compression for efficient data storage. An aspect of present disclosure relates to a method for managing data storage in a data storage system. The method includes the steps of determining, by a processor of said data storage system, receipt of one or more blocks of data for storage; identifying, by the processor, a compression technique for storage of said one or more blocks of data; and compressing in-line or post processing, by the processor, if said compression technique is an in-line compression technique for writing the data in a memory, said one or more blocks of data based at least on a resources utilization of said data storage system.

### TECHNICAL FIELD

The present invention relates to compression, in particular to an improved real-time adaptive data compression for efficient data storage.

### BACKGROUND

Background description includes information that may be useful in understanding the present invention. It is not an admission that any of the information provided herein is prior art or relevant to the presently claimed invention, or that any publication specifically or implicitly referenced is prior art.

Conventionally known, compression is a reduction in the number of bits needed to represent data. Compressing data can save storage capacity, speed file transfer, and decrease costs for storage hardware and network bandwidth. Data compression is often referred to as coding, where coding is a very general term encompassing any special representation of data which satisfies a given need. Information theory is defined to be the study of efficient coding and its consequences, in the form of speed of transmission and probability of error. Data compression may be viewed as a branch of information theory in which the primary objective is to minimize the amount of data to be transmitted.

Generally, the compression is performed by a program that uses a formula or algorithm to determine how to shrink the size of the data. For instance, an algorithm may represent a string of bits, or 0s and 1s, with a smaller string of 0s and 1s by using a dictionary for the conversion between them, or the formula may insert a reference or pointer to a string of 0s and 1s that the program has already seen. Text compression can be as simple as removing all unneeded characters, inserting a single repeat character to indicate a string of repeated characters, and substituting a smaller bit string for a frequently occurring bit string. Compression can reduce a text file to 50% or a significantly higher percentage of its original size. Compression algorithms reduce the size of the bit strings in a data stream that is far smaller in scope and generally remember no more than the last megabyte or less of data.

For data transmission, compression can be performed on the data content or on the entire transmission unit, including header data. When information is sent or received via the Internet, larger files, either singly or with others as part of an archive file, may be transmitted in a .ZIP, gzip or other compressed format.

Compressing data can be a lossless or lossy process. Lossless compression enables the restoration of a file to its original state, without the loss of a single bit of data, when the file is uncompressed. Lossless compression is the typical approach with executables, as well as text and spreadsheet files, where the loss of words or numbers would change the information. Lossy compression permanently eliminates bits of data that are redundant, unimportant or imperceptible. Lossy compression is useful with graphics, audio, video and images, where the removal of some data bits has little or no discernible effect on the representation of the content.

Graphics image compression can be lossy or lossless. Graphic image file formats are typically designed to compress information since the files tend to be large. JPEG is an image file format that supports lossy image compression. Formats such as GIF and PNG use lossless compression.

Compression is built into a wide range of technologies, including storage systems, databases, operating systems and software applications used by businesses and enterprise organizations. Compressing data is also common in consumer devices such as laptops, PCs and mobile phones. Many systems and devices perform compression transparently, but some give users the option to turn compression on or off. Compression can be performed more than once on the same file or piece of data, but subsequent compressions result in little to no additional compression and may even increase the size of the file to a slight degree, depending on the algorithms WinZip is a popular Windows program that compresses files when it packages them in an archive. Archive file formats that support compression include ZIP and RAR. The bzip2 and gzip formats see widespread use for compressing individual files.

Compression tends to be more effective in reducing the size of unique information such as image, audio, video, database and executable files. Many storage systems now-a-days support compression. The main advantages of compression are a reduction in storage hardware, data transmission time and communication bandwidth, and the resulting cost savings. A compressed file requires less storage capacity than an uncompressed file, and the use of compression can lead to a significant decrease in expenses for disk and/or solid-state drives. A compressed file also requires less time for transfer, and it consumes less network bandwidth than an uncompressed file.

The main disadvantage of compression is the performance impact resulting from the use of CPU and memory resources to compress and decompress the data. Many vendors have designed their systems to try to minimize the impact of the processor-intensive calculations associated with compression. If the compression runs inline, before the data is written to disk, the system may offload compression to preserve system resources. For instance, IBM uses a separate hardware acceleration card to handle compression with some of its enterprise storage systems.

If data is compressed after it is written to disk, or post process, the compression may run in the background to reduce the performance impact. Although post-process compression can reduce the response time for each input/output (I/O), it still consumes memory and processor cycles, and can affect the overall number of I/Os storage system can handle. Also, because data initially must be written to disk or flash drives in an uncompressed form, the physical storage savings are not as great as they are with inline compression.

Generally, data reduction/efficiency technologies are never zero cost. In view of the above, what is noted that, with compression specifically, if a storage system is able to perform any number of operations without compression, the number of storage operations that can be performed with in-line compression must be fewer. The problem in native in-line compression is that the impact on storage operations performance is fixed and impactful. This makes running compression on different hardware/software have very different performance profiles with compression or without compression. For example, running on system x without compression will yield 100 operations per second. Running on system x with in-line compression will yield 80 operations per second. 20% degradation due to in-line compression. Running on system y without compression will yield 200 operations per second. Running on system y with in-line compression will yield 100 operations per second. 50% degradation due to in-line compression.

Thus, there is a dire need to provide a mechanism which dynamically, in real-time, determines per operation whether to compress data in-line or post process such that the impact on storage operations performance is flexible and improved with efficiency without any impact on the available resources and operations. Further, there is also a need to provide a mechanism that makes running compression on different hardware/software have almost similar performance profiles with compression or without compression.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context.

The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

### SUMMARY

The present invention is mainly to solve the technical problems of the prior art existed. The present invention relates to compression, in particular to an improved real-time adaptive data compression for efficient data storage.

In an embodiment, the present invention provides a mechanism which dynamically, in real-time, determines per operation whether to compress data in-line or post process such that the impact on storage operations performance is flexible and improved with efficiency without any impact on the available resources and operations. Further, the present invention provides a mechanism that makes running compression on different hardware/software have almost similar performance profiles with compression or without compression.

An aspect of the present disclosure relates to a method for managing data storage in a data storage system. The method includes the steps of determining, by a processor of said data storage system, receipt of one or more blocks of data for storage; identifying, by the processor, a compression technique for storage of said one or more blocks of data; and compressing in-line or post processing, by the processor, if said compression technique is an in-line compression technique for writing the data in a memory, said one or more blocks of data based at least on a resources utilization of said data storage system.

In an aspect, said resources utilization is selected from any or combination of a CPU utilization, a memory utilization, a number of operations in flight, a NVRAM/NVDIMM utilization, a network utilization, a cache utilization, a drive utilization, and a node storage capacity/utilization.

In an aspect, the method further determines independent probabilities of said resources utilization of said data storage system to derive a probability of compressibility in-line value for automatically selecting compressing in-line or post processing said one or more blocks of data.

In an aspect, the method further updates a compression flag indicating selection of said compressing in-line for storage of said one or more blocks of data or updates a post process flag indicating selection of said post processing for storage of said one or more blocks of data.

An aspect of the present disclosure relates to a method of evaluating at least on a resources utilization of a data storage system to determine if a write received by said data storage system should be compressed in-line or post-process in order to maintain a consistent performance with in-line compression and without in-line compression, said resources utilization is selected from any or combination of a CPU utilization, a memory utilization, a number of operations in flight, a NVRAM/NVDIMM utilization, a network utilization, a cache utilization, a drive utilization, and a node storage capacity/utilization.

An aspect of the present disclosure relates to a system for managing data storage in a data storage system. The system includes a storage processor and a memory. The system is configured to determine, by said storage processor, receipt of one or more blocks of data for storage; identify, by said storage processor, a compression technique for storage of said one or more blocks of data; and compress in-line or post process, by said storage processor, if said compression technique is an in-line compression technique for writing the data in the memory, said one or more blocks of data based at least on a resources utilization of said data storage system to dynamically scale performance to match the available resources of said data storage system.

An aspect of the present disclosure relates to a data storage system comprising data storage, a storage processor and a memory. The data storage system is configured to determine, by said storage processor, receipt of one or more blocks of data for storage; identify, by said storage processor, a compression technique for storage of said one or more blocks of data; and compress in-line or post process, by said storage processor, if said compression technique is an in-line compression technique for writing the data in the memory, said one or more blocks of data based at least on a resources utilization of said data storage system.

Other features of embodiments of the present disclosure will be apparent from accompanying drawings and from detailed description that follows.

### BRIEF DESCRIPTION OF THE DRAWINGS

In the FIGURES, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary block diagram for managing data storage in a data storage system in accordance with an embodiment of the present invention.

### DETAILED DESCRIPTION

Systems and methods are disclosed for managing data storage in data storage systems. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of managing data storage in a data storage system, it should be appreciated that the same has been done merely to illustrate the invention in an exemplary manner and any other purpose or function for which explained structures or configurations can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the FIGURES may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Generally, data reduction/efficiency technologies are never zero cost. In view of the above, what is noted that, with compression specifically, if a storage system is able to perform any number of operations without compression, the number of storage operations that can be performed with in-line compression must be fewer. The problem in native in-line compression is that the impact on storage operations performance is fixed and impactful. This makes running compression on different hardware/software have very different performance profiles with compression or without compression. For example, running on system x without compression will yield 100 operations per second. Running on system x with in-line compression will yield 80 operations per second. 20% degradation due to in-line compression. Running on system y without compression will yield 200 operations per second. Running on system y with in-line compression will yield 100 operations per second. 50% degradation due to in-line compression.

Thus, there is a dire need to provide a mechanism which dynamically, in real-time, determines per operation whether to compress data in-line or post process such that the impact on storage operations performance is flexible and improved with efficiency without any impact on the available resources and operations. Further, there is also a need to provide a mechanism that makes running compression on different hardware/software have almost similar performance profiles with compression or without compression.

The present invention is mainly to solve the technical problems of the prior art existed. The present invention relates to compression, in particular to an improved real-time adaptive data compression for efficient data storage.

In an embodiment, the present invention provides a mechanism which dynamically, in real-time, determines per operation whether to compress data in-line or post process such that the impact on storage operations performance is flexible and improved with efficiency without any impact on the available resources and operations. Further, the present invention provides a mechanism that makes running compression on different hardware/software have almost similar performance profiles with compression or without compression.

An aspect of the present disclosure relates to a method for managing data storage in a data storage system. The method includes the steps of determining, by a processor of said data storage system, receipt of one or more blocks of data for storage; identifying, by the processor, a compression technique for storage of said one or more blocks of data; and compressing in-line or post processing, by the processor, if said compression technique is an in-line compression technique for writing the data in a memory, said one or more blocks of data based at least on a resources utilization of said data storage system.

In an aspect, said resources utilization is selected from any or combination of a CPU utilization, a memory utilization, a number of operations in flight, a NVRAM/NVDIMM utilization, a network utilization, a cache utilization, a drive utilization, and a node storage capacity/utilization.

In an aspect, the method further determines independent probabilities of said resources utilization of said data storage system to derive a probability of compressibility in-line value for automatically selecting compressing in-line or post processing said one or more blocks of data.

In an aspect, the method further updates a compression flag indicating selection of said compressing in-line for storage of said one or more blocks of data or updates a post process flag indicating selection of said post processing for storage of said one or more blocks of data

An aspect of the present disclosure relates to a method of evaluating at least on a resources utilization of a data storage system to determine if a write received by said data storage system should be compressed in-line or post-process in order to maintain a consistent performance with in-line compression and without in-line compression, said resources utilization is selected from any or combination of a CPU utilization, a memory utilization, a number of operations in flight, a NVRAM/NVDIMM utilization, a network utilization, a cache utilization, a drive utilization, and a node storage capacity/utilization.

An aspect of the present disclosure relates to a system for managing data storage in a data storage system. The system includes a storage processor and a memory. The system is configured to determine, by said storage processor, receipt of one or more blocks of data for storage; identify, by said storage processor, a compression technique for storage of said one or more blocks of data; and compress in-line or post process, by said storage processor, if said compression technique is an in-line compression technique for writing the data in the memory, said one or more blocks of data based at least on a resources utilization of said data storage system to dynamically scale performance to match the available resources of said data storage system.

An aspect of the present disclosure relates to a data storage system comprising data storage, a storage processor and a memory. The data storage system is configured to determine, by said storage processor, receipt of one or more blocks of data for storage; identify, by said storage processor, a compression technique for storage of said one or more blocks of data; and compress in-line or post process, by said storage processor, if said compression technique is an in-line compression technique for writing the data in the memory, said one or more blocks of data based at least on a resources utilization of said data storage system.

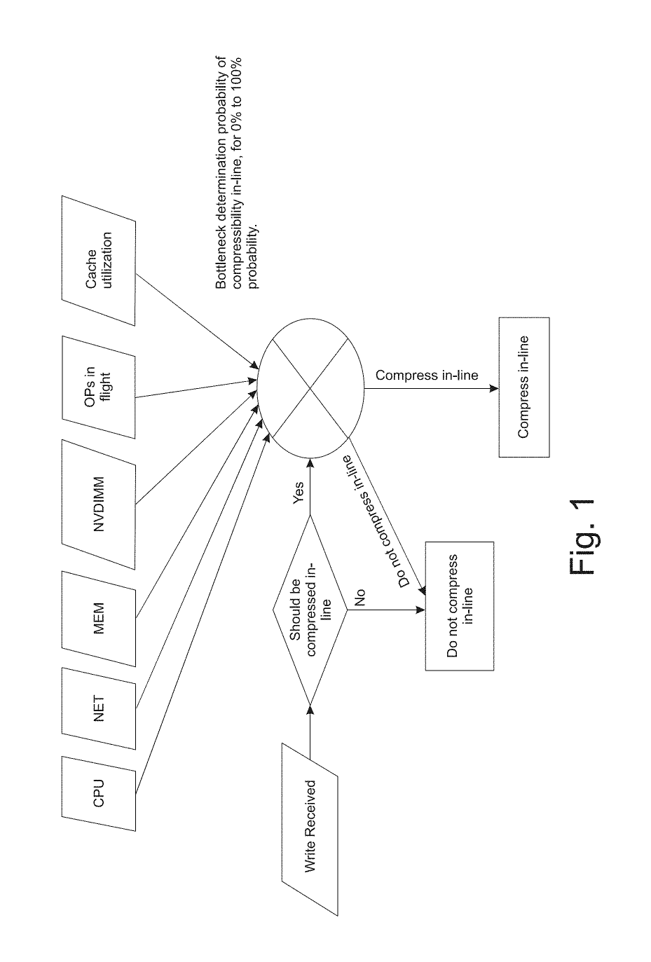

FIG. 1 illustrates an exemplary block diagram for managing data storage in a data storage system in accordance with an embodiment of the present invention. In an embodiment, as shown in FIG. 1, the present invention receives a block of data for storing in the data storage. At this point the present invention uses a number of inputs to determine if the block should be compressed in-line or post process. In an exemplary implementation, the current inputs used for determining this are not limited to, but include CPU utilization, memory utilization, and number of operations in flight, NVRAM/NVDIMM utilization, network utilization, cache utilization, drive utilization, and node storage capacity.

In an embodiment, the inputs can be pre-defined/pre-configured however, in an implementation their values are weighted different dynamically.

In an embodiment as shown in FIG. 1, a system may receive block of data for writing in the data storage. The system then determines if the block of data is to be compressed in-line or post process. If the block of data is to be compressed in-line the system determines an independent probabilities of resources utilization of said data storage system to derive a probability of compressibility in-line value for automatically selecting compressing in-line or post processing said one or more blocks of data.

In an embodiment, the method, according to the present invention, calculates the independent probabilities, chooses the ‘bottleneck’ probability, and then given that probability, it (probabilistically) determines whether the data should be compressed in-line or in a post process.

The said resources utilization is selected from any or combination of a CPU utilization, a memory utilization, a number of operations in flight, a NVRAM/NVDIMM utilization, a network utilization, a cache utilization, a drive utilization, and a node storage capacity/utilization.

In an exemplary implementation, said resources can be pre-defined but their values are weighted different dynamically.

For example, if a system had 20% CPU used and 90% memory used, the method would determine that memory is the bottleneck and probability for compressing the operation inline vs. post process would be 10% i.e. 10% of the operations would be compressed inline while 90% of the operations would be post processed for compression.

In an exemplary embodiment, said ‘bottleneck’ probabilities are multiplied for the said resources, thereby factoring in their criticality with a bias towards not compressing in-line/in-band and deferring to out-of-band compression.

Further, for each of the said resources, the present system divides their utilization into at least three ranges such as a low utilization range, a middle utilization range, and a high utilization range. If the resource usage is in the low utilization range, the present system considers the probability (for that resource) to be 100%. If the resource usage is in the high utilization range, the present system considers the probability (for that resource) to be 0%. If the resource usage is in the middle utilization range, the present system scale the probability linearly (negative slope) so that it matches the two end-points (where the middle utilization range meets the low/high utilization ranges). This per-resource probability is combined with the per-resource probabilities for all the relevant resources to determine the overall probability for the specific write. Given this combined probability, the present system probabilistically decides whether to perform in-band compression or not.

In an embodiment, the method, according to the present invention, evaluates a number of internal conditions (associated with the resources of the system) to determine if a write received by the storage system should be compressed in-line or post-process in order to maintain consistent performance with in-line compression and without in-line compression. Giving seemingly zero performance cost data efficiency regardless of the hardware.

In an embodiment, given any software or hardware system that is capable of running compression software, the present invention dynamically scales performance of the system to match the available resources.

It would be appreciated that, the present invention is applicable and would be applicable in any hardware or software instance that can use the software or capable of running compression software's.

In an embodiment, the system according to the present invention also includes a flag determining whether the data should be compressed in-line or whether the compression should be deferred to a post-process. In an exemplary implementation, a compression flag would be updated indicating selection of said compressing in-line for storage of said one or more blocks of data. In another implementation, a post process flag would be updated indicating selection of said post processing for storage of said one or more blocks of data.

In an embodiment, the system and/or the method according to the present invention determines compressibility inline vs. post process the method is able to scale performance and data efficiency based on the available resources in the system.

In an embodiment, the system and/or the method according to the present invention dynamically determines per operation whether to compress data in-line or post process.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A method for managing data storage in a data storage system, the method comprising:
determining, by a processor of said data storage system, receipt of one or more blocks of data for storage;
identifying, by the processor, a compression technique for storage of said one or more blocks of data;
wherein said method is characterized by comprising a step of:
compressing in-line or post processing, by the processor, if said compression technique is an in-line compression technique for writing the data in a memory, said one or more blocks of data based on combination of a CPU utilization, a memory utilization, and/or a number of operations in flight of said data storage system.

2. The method as claimed in claim 1, wherein said resources utilization is further selected from any or combination of, a NVRAM/NVDIMM utilization, a network utilization, a cache utilization, a drive utilization, and a node storage capacity/utilization.

3. The method as claimed in claim 1 further comprises: determining independent probabilities of said resources utilization of said data storage system to derive a probability of compressibility in-line value for automatically selecting compressing in-line or post processing said one or more blocks of data.

4. The method as claimed in claim 1 further comprises:
updating a compression flag indicating selection of said compressing in-line for storage of said one or more blocks of data; or
updating a post process flag indicating selection of said post processing for storage of said one or more blocks of data.

5. A method of evaluating at least on a resources utilization of a data storage system to determine if a write received by said data storage system should be compressed in-line or post-process in order to maintain a consistent performance with in-line compression and without inline compression, said resources utilization is selected from combination of a CPU utilization, a memory utilization, a number of operations in flight, a NVRAM/NVDIMM utilization, a network utilization, a cache utilization, a drive utilization, and a node storage capacity/utilization.

6. A system for managing data storage in a data storage system, the system comprising a storage processor and a memory configured to:
determine, by said storage processor, receipt of one or more blocks of data for storage;
identify, by said storage processor, a compression technique for storage of said one or more blocks of data;
wherein said system is characterized by comprising a step of:
compress in-line or post process, by said storage processor, if said compression technique is an in-line compression technique for writing the data in the memory, said one or more blocks of data based on combination of a CPU utilization, a memory utilization, and/or a number of operations in flight of said data storage system to dynamically scale performance to match the available resources of said data storage system.

7. The system as claimed in claim 6, wherein said resources utilization is further selected from any or combination of a NVRAM/NVDIMM utilization, a network utilization, a cache utilization, a drive utilization, and a node storage capacity/utilization.

8. The system as claimed in claim 6 further configured to: determine independent probabilities of said resources utilization of said data storage system to derive a probability of compressibility in-line value to automatically select compress in-line or post process said one or more blocks of data.

9. The system as claimed in claim 6 further configured to:
update a compression flag indicating selection of said compressing in-line for storage of said one or more blocks of data; or
update a post process flag indicating selection of said post processing for storage of said one or more blocks of data.

10. A data storage system comprising a data storage, a storage processor and a memory, said data storage system configured to:
determine, by said storage processor, receipt of one or more blocks of data for storage;
identify, by said storage processor, a compression technique for storage of said one or more blocks of data;
wherein said system is characterized by comprising a step of:
compress in-line or post process, by said storage processor, if said compression technique is an in-line compression technique for writing the data in the memory, said one or more blocks of data based on combination of a CPU utilization, a memory utilization, and/or a number of operations in flight of said data storage system.
